(19) United States
(12) Patent Application Publication
(10) Pub. No.: US 2006/0072449 A1
(43) Pub. Date: Apr. 6, 2006

(54) Method and system for channel equalization

(76) Inventors: Mark Kent, Vista, CA (US); Vinko Erceg, Cardiff, CA (US); Uri Landau, San Diego, CA (US); Pieter van Rooyen, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 11/173,502

(22) Filed: Jun. 30, 2005

Related U.S. Application Data
(60) Provisional application No. 60/616,895, filed on Oct. 6, 2004.

(51) Int. Cl. H04J 11/00

(52) U.S. Cl. 370/203

(57) ABSTRACT

Methods and systems for processing signals in a receiver are disclosed herein and may comprise generating at least one channel estimate of a time varying impulse response for at least one of a plurality of received clusters within at least one received signal, where a cluster may comprise an aggregate of continuously processed received multipaths. The generated channel estimate may be transformed to at least one flat fading channel estimate utilizing at least one signal-to-noise ratio optimization algorithm. Complex waveforms, comprising in-phase (I) and quadrature (Q) components, may be processed for the plurality of received clusters within the received signal, and the processed complex waveforms may be filtered. The resulting filtered waveforms may be convolved with the generated channel estimate to generate a convolved input signal. A weight signal for the transforming may be generated, utilizing the at least one signal-to-noise ratio optimization algorithm and the generated convolved input signal.

### CROSS-REFERENCE TO RELATED APPLICATIONS/INCORPORATION BY REFERENCE

This application makes reference, claims priority to, and claims the benefit of U.S. Provisional Application Ser. No. 60/616,895 filed Oct. 6, 2004.

This application is related to the following applications, each of which is incorporated herein by reference in its entirety:
U.S. patent application Ser. No. ______ (Attorney Docket No. 16199US02) filed ______, 2005;
U.S. patent application Ser. No. ______ (Attorney Docket No. 16200US02) filed ______, 2005;
U.S. patent application Ser. No. ______ (Attorney Docket No. 16202US02) filed ______, 2005;
U.S. patent application Ser. No. ______ (Attorney Docket No. 16203US02) filed ______, 2005;
U.S. patent application Ser. No. ______ (Attorney Docket No. 16204US02) filed ______, 2005;
U.S. patent application Ser. No. ______ (Attorney Docket No. 16205US02) filed ______, 2005;
U.S. patent application Ser. No. ______ (Attorney Docket No. 16206US02) filed ______, 2005;
U.S. patent application Ser. No. ______ (Attorney Docket No. 16207US02) filed ______, 2005;
U.S. patent application Ser. No. ______ (Attorney Docket No. 16208US02) filed ______, 2005;
U.S. patent application Ser. No. ______ (Attorney Docket No. 16209US02) filed ______, 2005;
U.S. patent application Ser. No. ______ (Attorney Docket No. 16210US02) filed ______, 2005;
U.S. patent application Ser. No. ______ (Attorney Docket No. 16211US02) filed ______, 2005;
U.S. patent application Ser. No. ______ (Attorney Docket No. 16212US02) filed ______, 2005;
U.S. patent application Ser. No. ______ (Attorney Docket No. 16213US02) filed ______, 2005;
U.S. patent application Ser. No. ______ (Attorney Docket No. 16214US02) filed ______, 2005;
U.S. patent application Ser. No. ______ (Attorney Docket No. 16215US02) filed ______, 2005;
U.S. patent application Ser. No. ______ (Attorney Docket No. 16216US02) filed ______, 2005;
U.S. patent application Ser. No. ______ (Attorney. Docket No. 16217US02) filed ______, 2005;
U.S. patent application Ser. No. ______ (Attorney Docket No. 16218US02) filed ______, 2005;
U.S. patent application Ser. No. ______ (Attorney Docket No. 16219US02) filed ______, 2005; and
U.S. patent application Ser. No. ______ (Attorney Docket No. 16220US02) filed ______, 2005.

### FIELD OF THE INVENTION

Certain embodiments of the invention relate to processing received radio frequency (RF) signals. More specifically, certain embodiments of the invention relate to a method and system for channel equalization.

### BACKGROUND OF THE INVENTION

Mobile communications have changed the way people communicate and mobile phones have been transformed from a luxury item to an essential part of every day life. The use of mobile phones is today dictated by social situations, rather than hampered by location or technology. While voice connections fulfill the basic need to communicate, and mobile voice connections continue to filter even further into the fabric of every day life, the mobile Internet is the next step in the mobile communication revolution. The mobile Internet is poised to become a common source of everyday information, and easy, versatile mobile access to this data will be taken for granted.

Third generation (3G) cellular networks have been specifically designed to fulfill these future demands of the mobile Internet. As these services grow in popularity and usage, factors such as cost efficient optimization of network capacity and quality of service (QoS)-will become even more essential to cellular operators than it is today. These factors may be achieved with careful network planning and operation, improvements in transmission methods, and advances in receiver techniques. To this end, carriers need technologies that will allow them to increase downlink throughput and, in turn, offer advanced QoS capabilities and speeds that rival those delivered by cable modem and/or DSL service providers. In this regard, networks based on wideband CDMA (WCDMA) technology may make the delivery of data to end users a more feasible option for today's wireless carriers.

FIG. 1a is a technology timeline indicating evolution of existing WCDMA specification to provide increased downlink throughput. Referring to FIG. 1a, there is shown data rate spaces occupied by various wireless technologies, including General Packet Radio Service (GPRS) 100, Enhanced Data rates for GSM (Global System for Mobile communications) Evolution (EDGE) 102, Universal Mobile Telecommunications System (UMTS) 104, and High Speed Downlink Packet Access (HSDPA) 106.

The GPRS and EDGE technologies may be utilized for enhancing the data throughput of present second generation (2G) systems such as GSM. The GSM technology may support data rates of up to 14.4 kilobits per second (Kbps), while the GPRS technology, introduced in 2001, may support data rates of up to 115 Kbps by allowing up to 8 data time slots per time division multiple access (TDMA) frame. The GSM technology, by contrast, may allow one data time slot per TDMA frame. The EDGE technology, introduced in 2003, may support data rates of up to 384 Kbps. The EDGE technology may utilizes 8 phase shift keying (8-PSK) modulation for providing higher data rates than those that may be achieved by GPRS technology. The GPRS and EDGE technologies may be referred to as “2.5G” technologies.

The UMTS technology, introduced in 2003, with theoretical data rates as high as 2 Mbps, is an adaptation of the WCDMA 3G system by GSM. One reason for the high data rates that may be achieved by UMTS technology stems from the 5 MHz WCDMA channel bandwidths versus the 200 KHz GSM channel bandwidths. The HSDPA technology is an Internet protocol (IP) based service, oriented for data communications, which adapts WCDMA to support data transfer rates on the order of 10 megabits per second (Mbits/s). Developed by the 3G Partnership Project (3GPP) group, the HSDPA technology achieves higher data rates through a plurality of methods. For example, many transmission decisions may be made at the base station level, which is much closer to the user equipment as opposed to being made at a mobile switching center or office. These may include decisions about the scheduling of data to be transmitted, when data is to be retransmitted, and assessments about the quality of the transmission channel. The HSDPA technology may also utilize variable coding rates. The HSDPA technology may also support 16-level quadrature amplitude modulation (16-QAM) over a high-speed downlink shared channel (HS-DSCH), which permits a plurality of users to share an air interface channel

In some instances, HSDPA may provide a two-fold improvement in network capacity as well as data speeds up to five times (over 10 Mbit/s) higher than those in even the most advanced 3G networks. HSDPA may also shorten the roundtrip time between network and terminal, while reducing variances in downlink transmission delay. These performance advances may translate directly into improved network performance and higher subscriber satisfaction. Since HSDPA is an extension of the WCDMA family, it also builds directly on the economies of scale offered by the world's most popular mobile technology. HSDPA may offer breakthrough advances in WCDMA network packet data capacity, enhanced spectral and radio access networks (RAN) hardware efficiencies, and streamlined network implementations. Those improvements may directly translate into lower cost-per-bit, faster and more available services, and a network that is positioned to compete more effectively in the data-centric markets of the future.

The capacity, quality and cost/performance advantages of HSDPA yield measurable benefits for network operators, and, in turn, their subscribers. For operators, this backwards-compatible upgrade to current WCDMA networks is a logical and cost-efficient next step in network evolution. When deployed, HSDPA may co-exist on the same carrier as the current WCDMA Release 99 services, allowing operators to introduce greater capacity and higher data speeds into existing WCDMA networks. Operators may leverage this solution to support a considerably higher number of high data rate users on a single radio carrier. HSDPA makes true mass-market mobile IP multimedia possible and will drive the consumption of data-heavy services while at the same time reducing the cost-per-bit of service delivery, thus boosting both revenue and bottom-line network profits. For data-hungry mobile subscribers, the performance advantages of HSDPA may translate into shorter service response times, less delay and faster perceived connections. Users may also download packet-data over HSDPA while conducting a simultaneous speech call.

HSDPA may provide a number of significant performance improvements when compared to previous or alternative technologies. For example, HSDPA extends the WCDMA bit rates up to 10 Mbps, achieving higher theoretical peak rates with higher-order modulation (16-QAM) and with adaptive coding and modulation schemes. The maximum QPSK bit rate is 5.3 Mbit/s and 10.7 Mbit/s with 16-QAM. Theoretical bit rates of up to 14.4 Mbit/s may be achieved with no channel coding. The terminal capability classes range from 900 Kbit/s to 1.8 Mbit/s with QPSK modulation, and 3.6 Mbit/s and up with 16-QAM modulation. The highest capability class supports the maximum theoretical bit rate of 14.4 Mbit/s.

However, implementing advanced wireless technologies such as WCDMA and/or HSDPA may still require overcoming some architectural hurdles. For example, the RAKE receiver is the most commonly used receiver in CDMA systems, mainly due to its simplicity and reasonable performance and WCDMA Release 99 networks are designed so that RAKE receivers may be used. A RAKE receiver contains a bank of spreading sequence correlators, each receiving an individual multipath. A RAKE receiver operates on multiple discrete paths. The received multipath signals can be combined in several ways, from which maximal ratio combining (MRC) is preferred in a coherent receiver. However, a RAKE receiver may be suboptimal in many practical systems, for example, its performance may degrade from multiple access interference (MAI), that is, interference induced by other users in the network.

In the case of a WCDMA downlink, MAI may result from inter-cell and intracell interference. The signals from neighboring base stations compose intercell interference, which is characterized by scrambling codes, channels and angles of arrivals different from the desired base station signal. Spatial equalization may be utilized to suppress inter-cell interference. In a synchronous downlink application, employing orthogonal spreading codes, intra-cell interference may be caused by multipath propagation. Due to the non-zero cross-correlation between spreading sequences with arbitrary time shifts, there is interference between propagation paths (or RAKE fingers) after despreading, causing MAI and inter-path interference (IPI). The level of intra-cell interference depends strongly on the channel response. In nearly flat fading channels, the physical channels remain almost completely orthogonal and intra-cell interference does not have any significant impact on the receiver performance. On the other hand, the performance of the RAKE receiver may be severely deteriorated by intra-cell interference in frequency selective channels. Frequency selectivity is common for the channels in WCDMA networks.

To combat MAI, linear interference suppression algorithms can be utilized, which are based on linear channel equalization and are suitable for WCDMA/HSDPA systems using long, orthogonal scrambling codes. Due to the difficulties faced when non-linear channel equalizers are applied to the WCDMA downlink, detection of the desired physical channel with a non-linear equalizer may result in implementing an interference canceller or optimal multi-user receiver. Both types of receivers may be prohibitively complex for mobile terminals and may require information not readily available at the mobile terminal. Alternatively, the total base station signal may be considered as the desired signal. However, non-linear equalizers rely on prior knowledge of the constellation of the desired signal, and this information is not readily available at the WCDMA terminal. The constellation of the total base station signal, that is, sum of all physical channels, is a high order quadrature amplitude modulation (QAM) constellation with uneven spacing. The spacing of the constellation changes constantly due to transmission power control (TPC) and possible power offsets between the control data fields, time-multiplexed to the dedicated physical channels. The constellation order may also frequently change due to discontinuous transmission. This makes an accurate estimation of the constellation very difficult.

In this regard, the use of multiple transmit and/or receive antennas may result in an improved overall system performance. These multi-antenna configurations, also known as smart antenna techniques, may be utilized to mitigate the negative effects of multipath and/or signal interference on signal reception. It is anticipated that smart antenna techniques may be increasingly utilized both in connection with the deployment of base station infrastructure and mobile subscriber units in cellular systems to address the increasing capacity demands being placed on those systems. These demands arise, in part, from a shift underway from current voice-based services to next-generation wireless multimedia services that provide voice, video, and data communication.

The utilization of multiple transmit and/or receive antennas is designed to introduce a diversity gain and array gain and to suppress interference generated within the signal reception process. Such diversity gains improve system performance by increasing received signal-to-noise ratio, by providing more robustness against signal interference, and/or by permitting greater frequency reuse for higher capacity. In communication systems that incorporate multi-antenna receivers, a set of M receive antennas may be utilized to null the effect of (M−1) interferers, for example. Accordingly, N signals may be simultaneously transmitted in the same bandwidth using N transmit antennas, with the transmitted signal then being separated into N respective signals by way of a set of N antennas deployed at the receiver. Systems that utilize multiple transmit and receive antennas may be referred to as multiple-input multiple-output (MIMO) systems. One attractive aspect of multi-antenna systems, in particular MIMO systems, is the significant increase in system capacity that may be achieved by utilizing these transmission configurations. For a fixed overall transmitted power, the capacity offered by a MIMO configuration may scale with the increased signal-to-noise ratio (SNR).

However, the widespread deployment of multi-antenna systems in wireless communications, particularly in wireless handset devices, has been limited by the increased cost that results from increased size, complexity, and power consumption. Providing a separate RF chain for each transmit and receive antenna is a direct factor that increases the cost of multi-antenna systems. Each RF chain generally comprises a low noise amplifier (LNA), a filter, a downconverter, and an analog-to-digital converter (A/D). In certain existing single-antenna wireless receivers, the single required RF chain may account for over 30% of the receiver's total cost. It is therefore apparent that as the number of transmit and receive antennas increases, the system complexity, power consumption, and overall cost may increase. This poses problems for mobile system designs and applications.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and method for channel equalization, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1a is a technology timeline indicating evolution of existing WCDMA specification to provide increased downlink throughput.

FIG. 1b illustrates an exemplary HSDPA distributed architecture that achieves low delay link adaptation, in connection with an embodiment of the invention.

FIG. 1c illustrates an exemplary Layer 1 HARQ control situated in a base station to remove retransmission-related scheduling and storing from the radio network controller, in connection with an embodiment of the invention.

FIG. 1d is a chart illustrating exemplary average carried loads for HSDPA-based macrocell and microcell systems, in connection with an embodiment of the invention.

FIG. 2A is an exemplary bandpass signal processor, in accordance with an embodiment of the invention.

FIG. 2B is an exemplary maximum-ratio combining (MRC) block, in accordance with an embodiment of the invention.

FIG. 3 illustrates exemplary signal processing circuitry, which performs channel equalization, in accordance with an embodiment of the invention.

FIG. 4 is a flow diagram illustrating exemplary steps for signal equalization, in accordance with an embodiment of the invention.

### DETAILED DESCRIPTION OF THE INVENTION

Certain aspects of the invention may be found in a method and system for processing signals in a receiver. In accordance with an exemplary aspect of the invention, a channel equalizer may be utilized to transform a received signal channel for at least one received signal cluster from a frequency selective channel to a flat fading channel, where a cluster may comprise an aggregate of continuously processed received multipaths. In this regard, the clusters are continuously processed as opposed to being discretely processed. During the channel transformation, the equalizer may utilize one or more signal-to-noise ratio optimization algorithms as well as one or more convolution operations. A plurality of equalizer weights may also be utilized during the frequency selective channel transformation, where each equalizer weight may be calculated with an adaptive algorithm that may be configured to iteratively search for optimum weight solution.

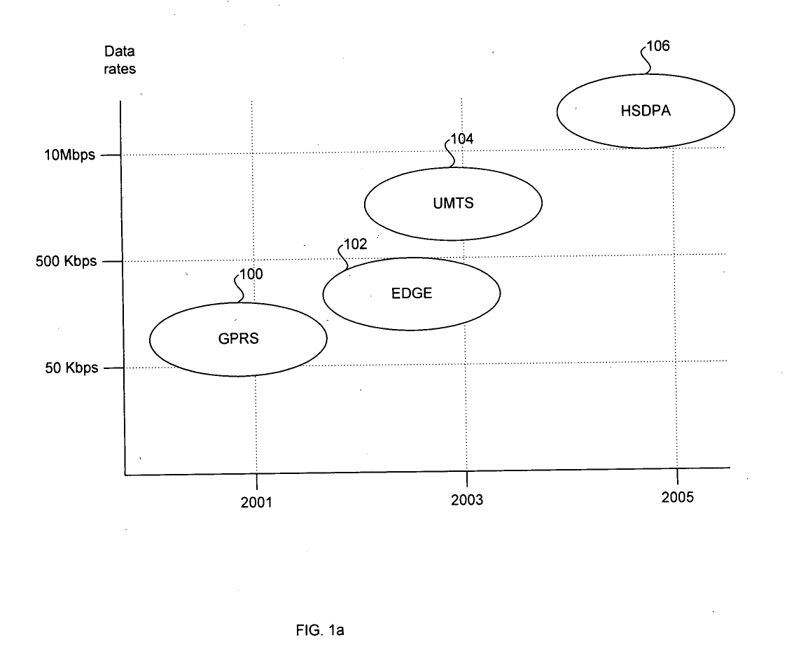

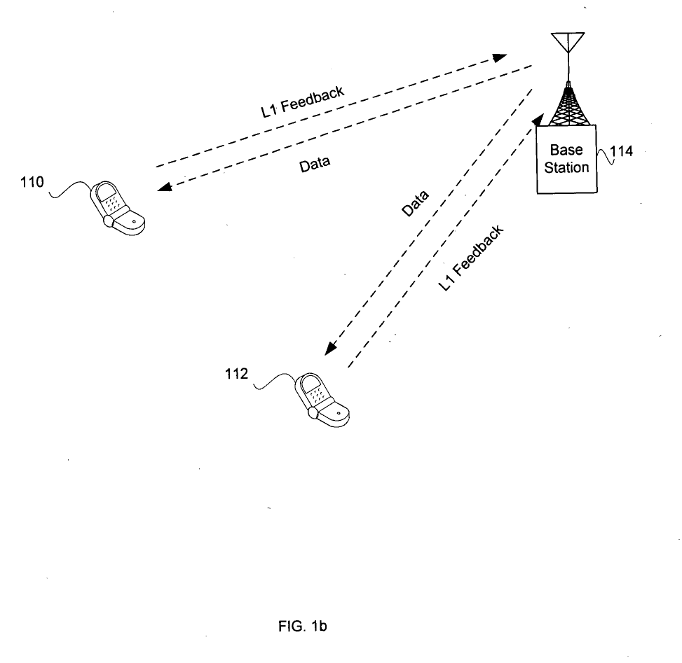

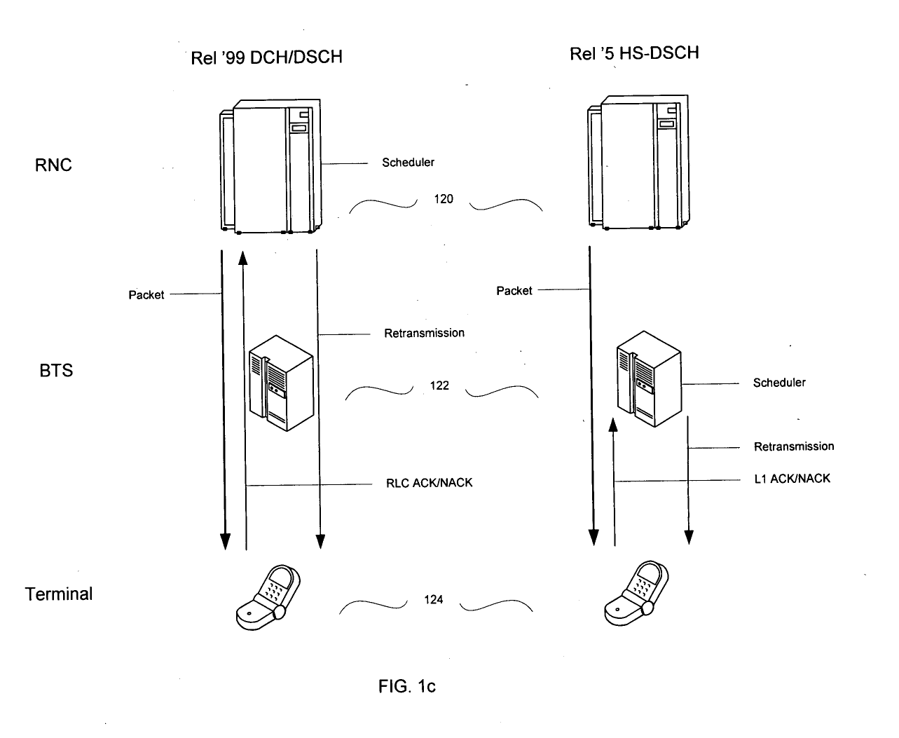

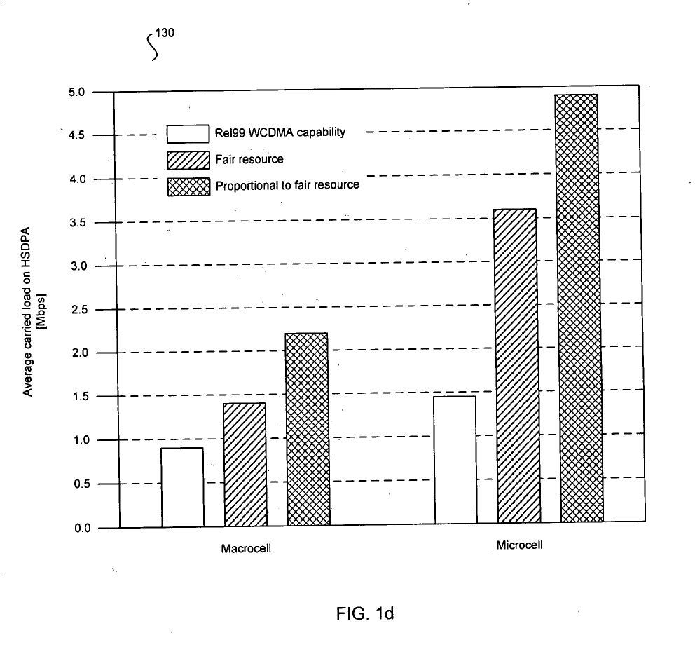

FIG. 1b illustrates an exemplary HSDPA distributed architecture that achieves low delay link adaptation, in connection with an embodiment of the invention. Referring to FIG. 1b, there is shown terminals 110 and 112 and a base station (BS) 114. HSDPA is built on a distributed architecture that achieves low delay link adaptation by placing key processing at the BS 114, which may be a medium access control (MAC), closer to the physical layer (PHY) air interface as illustrated. HSDPA leverages methods that are well established within existing GSM/EDGE standards, including fast physical layer (L1) retransmission combining and link adaptation techniques, to deliver significantly improved packet data throughput performance between the mobile terminals 110 and 112 and the BS 114.

The HSDPA technology employs several important new technological advances. Some of these may comprise scheduling for the downlink packet data operation at the BS 114, higher order modulation, adaptive modulation and coding, hybrid automatic repeat request (HARQ), physical layer feedback of the instantaneous channel condition, and a new transport channel type known as high-speed downlink shared channel (HS-DSCH) that allows several users to share the air interface channel. When deployed, HSDPA may co-exist on the same carrier as the current WCDMA and UMTS services, allowing operators to introduce greater capacity and higher data speeds into existing WCDMA networks. HSDPA replaces the basic features of WCDMA, such as variable spreading factor and fast power control, with adaptive modulation and coding, extensive multicode operation, and fast and spectrally efficient retransmission strategies.

In current-generation WCDMA networks, power control dynamics are on the order of 20 dB in the downlink and 70 dB in the uplink. WCDMA downlink power control dynamics are limited by potential interference between users on parallel code channels and by the nature of WCDMA base station implementations. For WCDMA users close to the base station, power control cannot reduce power optimally, and reducing power beyond the 20 dB may therefore have only a marginal impact on capacity. HSDPA, for example, utilizes advanced link adaptation and adaptive modulation and coding (AMC) to ensure all users enjoy the highest possible data rate. AMC therefore adapts the modulation scheme and coding to the quality of the appropriate radio link.

FIG. 1c illustrates an exemplary Layer 1 HARQ control situated in a base station to remove retransmission-related scheduling and storing from the radio network controller, in connection with an embodiment of the invention. Referring to FIG. 1c, there is shown a hybrid automatic repeat request (HARQ) operation, which is an operation designed to reduce the delay and increase the efficiency of retransmissions. Layer 1 HARQ control is situated in the Node B, or base station (BS), 122 thus removing retransmission-related scheduling and storing from the radio network controller (RNC) 120. This HARQ approach avoids hub delay and measurably reduces the resulting retransmission delay.

For example, when a link error occurs, due to signal interference or other causes, a mobile terminal 124 may request the retransmission of the data packets. While current-generation WCDMA networks handle those retransmission requests through the radio network controller 120, HSDPA retransmission requests are managed at the base station 122. Furthermore, received packets are combined at the physical (PHY) layer and retrieved only if successfully decoded. If decoding has failed, the new transmission is combined with the old transmission before channel decoding. The HSDPA approach allows previously transmitted frames (that failed to be decoded) to be combined with the retransmission. This combining strategy provides improved decoding efficiencies and diversity gains while minimizing the need for additional repeat requests.

While the spreading factor may be fixed, the coding rate may vary between ¼ and ¾, and the HSDPA specification supports the use of up to 10 multicodes. More robust coding, fast HARQ, and multi-code operation eliminates the need for variable spreading factor and also allows for more advanced receiver structures in the mobile such as equalizers as apposed to the traditional RAKE receiver used in most CDMA systems. This approach may also allow users having good signal quality or higher coding rates and those at the more distant edge of the cell having lower coding rates to each receive an optimum available data rate.

By moving data traffic scheduling to the base station 122, and thus closer to the air interface, and by using information about channel quality, terminal capabilities, QoS, and power/code availability, HSDPA may achieve more efficient scheduling of data packet transmissions. Moving these intelligent network operations to the base station 122 allows the system to take full advantage of short-term variations, and thus to speed and simplify the critical transmission scheduling process. The HSDPA approach may, for example, manage scheduling to track the fast fading of the users and when conditions are favorable to allocate most of the cell capacity to a single user for a very short period of time. At the base station 122, HSDPA gathers and utilizes estimates of the channel quality of each active user. This feedback provides current information on a wide range of channel physical layer conditions, including power control, ACK/NACK ratio, QoS, and HSDPA-specific user feedback.

While WCDMA Release 99 or WCDMA Release 4 may support a downlink channel (DCH) or a downlink shared channel (DSCH), the HSDPA operation provided by WCDMA Release 5 may be carried on a high-speed downlink shared channel (HS-DSCH). This higher-speed approach uses a 2-ms interval frame length (also known as time transmit interval), compared to DSCH frame lengths of 10, 20, 40 or 80 ms. DSCH utilizes a variable spreading factor of 4 to 256 chips while HS-DSCH may utilize a fixed spreading factor of 16 with a maximum of 15 codes. HS-DSCH may support 16-level quadrature amplitude modulation (16-QAM), link adaptation, and the combining of retransmissions at the physical layer with HARQ. HSDPA also leverages a high-speed shared control channel (HS-SCCH) to carry the required modulation and retransmission information. An uplink high-speed dedicated physical control channel (HS-DPCCH) carries ARQ acknowledgements, downlink quality feedback and other necessary control information on the uplink.

FIG. 1d is a chart illustrating exemplary average carried loads for HSDPA-based macrocell and microcell systems, in connection with an embodiment of the invention. Referring to the chart 130 in FIG. 1d, in practical deployments, HSDPA more than doubles the achievable peak user bit rates compared to WCDMA Release 99. With bit rates that are comparable to DSL modem rates, HS-DSCH may deliver user bit rates 134 in large macrocell environments exceeding 1 Mbit/s, and rates 140 in small microcells up to 5 Mbit's. The HSDPA approach supports both non-real-time UMTS QoS classes and real-time UMTS QoS classes with guaranteed bit rates.

Cell throughput, defined as the total number of bits per second transmitted to users through a single cell, increases 100% with HSDPA when compared to the WCDMA Release 99. This is because HSDPA's use of HARQ combines packet retransmission with the earlier transmission, and thus no transmissions are wasted. Higher order modulation schemes, such as 16-QAM, enable higher bit rates than QPSK-only modulation in WCDMA Release 99, even when the same orthogonal codes are used in both systems. The highest throughput may be obtained with low inter-path interference and low inter-cell interference conditions. In microcell designs, for example, the HS-DSCH may support up to 5 Mbit/s per sector per carrier, or 1 bit/s/Hz/cell.

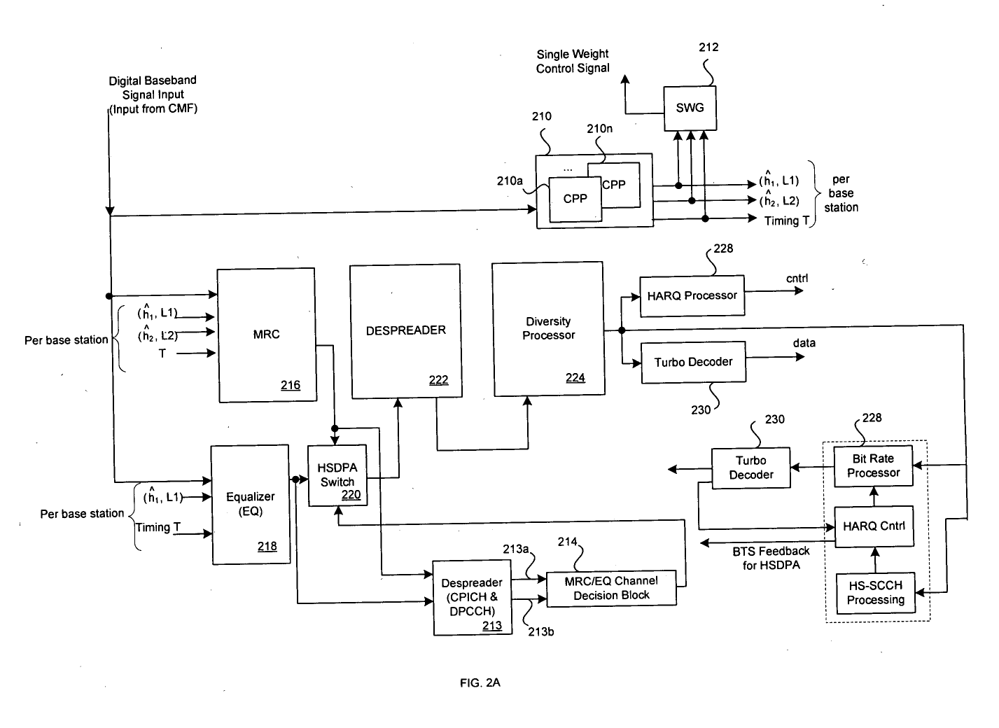

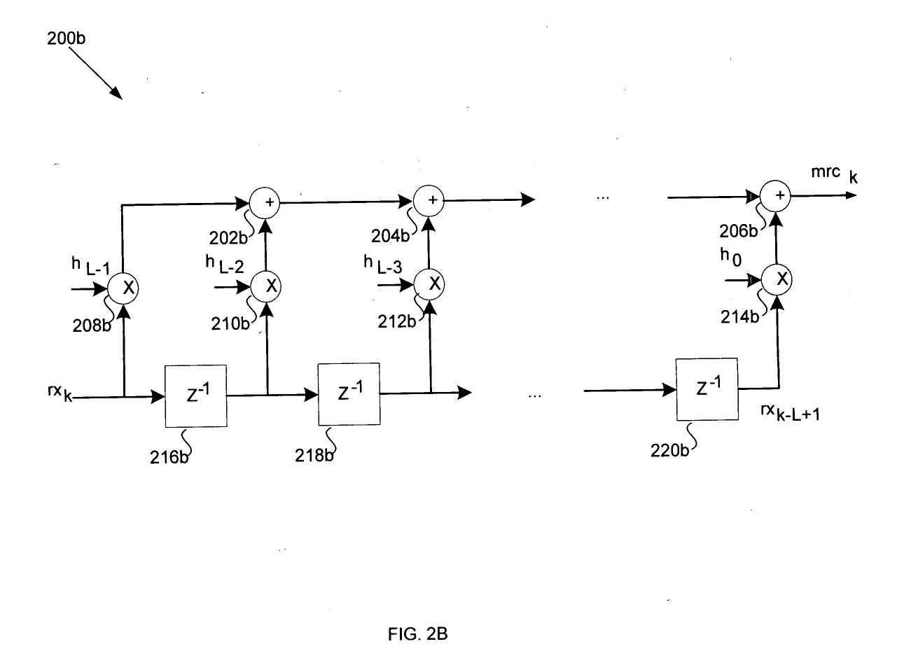

FIG. 2A is a block diagram of an exemplary baseband signal processor, in accordance with an embodiment of the invention. Referring to FIG. 2A, there is shown a baseband processor 200 which may comprise a cluster path processor (CPP) 210, a single-weight generator (SWG) 212, a maximal ratio combiner/equalizer (MRC/EQ) channel decision block 214, a despreader for common and dedicated pilot signals block 213, a maximum ratio combiner (MRC) 216, an equalizer (EQ) 218, a HSPDA switch 220, a despreader 222, diversity processor 224, a convolutional decoder 228, and a turbo decoder 230. FIG. 2A further comprises a plurality of signals including a single weight control signal, a digital baseband signal input, estimates ĥ₁ and ĥ₂ of the actual time varying impulse response of the channel per base station, a timing signal per base station, output signal A1, a voice signal, and a data signal.

The weight control signal may be a signal generated by the SWG 212 and may be utilized to control a phase shifter, for example. The digital baseband signal may be an output of an RF block in a receiver front end and may be communicated to the broadband processor 200 for further processing. Estimates ĥ₁ and ĥ₂ generated by the CPP 210 may be the channel estimations of the actual time varying impulse response of the channel per base station. Corresponding lock indicators L1 and L2, per base station, may also be generated by the CPP 210. The lock indicators L1 and L2 may provide an indication of which components in the corresponding estimates comprise valid component values. The timing reference signal T per base station may be a signal generated by the CPP 210 as well. The signal A1 may be a signal generated by the MRC/EQ channel decision block 214 that may be utilized by the HSDPA switch 220 to select the output of the MRC 216 or the EQ 218. The voice signal and the data signal may be outputs of the convolutional decoder 228 and the turbo decoder 230, respectively, and may be communicated to other processors, such as a vocoder and a digital display processor, for example.

The baseband processor 200 may comprise suitable logic, circuitry and/or code that may be adapted to process the digital baseband signal input to generate the single weight control signal, the voice signal, and the data signal, for example. Specifically, the CPP 210 may comprise suitable logic, circuitry and/or code that may be adapted to track in time and estimate a complex phase and/or amplitude values of elements in a cluster, where a cluster may be an aggregate of received multipath signals. The SWG 212 may comprise suitable logic, circuitry and/or code that may be adapted to generate the single weight control signal for a phase shifter within a pre-equalization block, for example.

The CPP block 210 may comprise a plurality of cluster path processors CPPs 210a, . . . , 210n that may be adapted to receive and process an output of a chip matched filter (CMF) block (not pictured), for example. The CPPs 210a, . . . , 210n within the CPP block 210 may be partitioned into pairs of processors, wherein each pair of processor may be adapted to track time-wise and estimate the complex phase and amplitude of the element in the cluster. A cluster may comprise an aggregate of received signals paths with maximum (max) time difference that may be no more than 16×1/3.84e6 (sec), for example. Under these circumstances, the need for two processors is derived from the fact that the WCDMA standard facilitates a receiving mode in which the transmitted signal is communicated over two antennas, which necessitates the two processors. These receiving modes may comprise close loop 1 (CL1), close loop 2 (CL2), and STTD. The CPP block 210 is adapted to determine estimates of the entire transfer function of the channel and recovers channels on a per base station basis. The channel estimates ĥ₁ and ĥ2, along with lock indicators L1 and L2, and timing information T, may be generated on a per base station basis. An embodiment of the invention may use a strength of a received signal to assert the lock indicators.

The MRC/EQ channel decision block 214 may comprise suitable logic, circuitry and/or code that may be adapted to generate a signal A1 which may be utilized to select either the output from the MRC 216 or the EQ 218. For example, for high Doppler values, where one or more transmit antennas and/or one or more receive antennas may be moving at high speeds with respect to each other, the MRC 216 may yield better performance than the EQ 218 because of slow EQ convergence time. For high delay spread values, MRC 216 may be selected. For high Doppler values, high pilot filter bandwidth values may be selected. Pilot filter bandwidth may influence channel estimation accuracy and may be set to more averaging (filtering) when Doppler values may be low. Also, MRC 216 and EQ 218 pilot filter bandwidth values may be different for the same value of Doppler. For a system that may use multiple antenna channel estimation using phase rotation, MRC 216 may yield better modem performance. Based on a received signal tuple (xEQ, nEQ), the maximum ratio combining and equalization channel decision control block 214 may generate an equalizer control signal that may be utilized to control the operation of the equalizer 218.

The despreader for common and dedicated pilot signals block 213 may comprise suitable circuitry, logic, and/or code that may be adapted to utilize received signals from the maximum ratio combiner 216, and to compute estimates for at least a portion of transmitter input signals x1, x2, . . . xn. In addition, the despreader for common and dedicated pilot signals block 213 may compute estimates for noise, 213a and 213b, contained in the received signal from the maximum ratio combiner 216. Noise components 213a and 213b may have been introduced while the received signal from a transmitter was propagated through the transmission medium between the transmitter and the receiver.

The maximum-ratio combining block 216 may comprise suitable logic, circuitry and/or code to receive timing reference signals, T, and channel estimates and lock indicators, (ĥ1,L1) and (ĥ2,L2), from the corresponding cluster path processor block 210, which may be utilized by the maximum-ratio combining block 216 to process received signals from a chip matched filter (CMF) block, for example. The maximum ratio combining block 216 may utilize channel estimate components that are valid in accordance with the corresponding lock indicator. Channel estimate components that are not valid, in accordance with the corresponding lock indicator, may not be utilized. The maximum-ratio combining block 216 may be adapted to provide a combining scheme or mechanism for implementing a rake receiver which may be utilized with adaptive antenna arrays to combat noise, fading, and/or co-channel interference.

In accordance with an embodiment of the invention, the maximum-ratio combining block 216 may comprise suitable logic, circuitry, and/or code that may be adapted to add individual distinct path signals, received from the assigned RF channel, together in such a manner to achieve the highest attainable signal to noise ratio (SNR). The highest attainable SNR may be based upon a maximal ratio combiner. A maximal ratio combiner is a diversity combiner in which each of multipath signals from all received multipaths are added together, each with unique gain. The gain of each multipath before summing can be made proportional to received signal level for the multipath, and inversely proportional to the multipath noise level. Each of the maximum-ratio combining blocks may be also adapted to utilize other techniques for signal combining such selection combiner, switched diversity combiner, equal gain combiner, or optimal combiner.

In various embodiments of the invention, the assignment of fingers in the maximum-ratio combining block 216 may be based on the timing reference signal, T, from the cluster path processor block 210. The proportionality constants utilized in the maximum-ratio combining block 216 may be based on the valid channel estimates, ĥ₁ and ĥ₂, from the cluster path processor block 210.

The EQ 218 may comprise suitable logic, circuitry and/or code that may be adapted to transform the channel from a frequency selective channel to a flat fading channel. In this regard, the equalization block EQ 218 may be adapted to utilize, for example, an adaptive algorithm to adaptively calculate weights and iteratively search for an optimal weight solution. The equalization block 218 may receive timing reference signals, T, and channel estimates and lock indicators, (ĥ₁,L₁) and (ĥ₂,L₂), from the corresponding cluster path processor block 210, which may be utilized to calculate weights. The equalization block 218 may utilize channel estimate components in accordance with the corresponding lock indicator, utilizing channel estimate components that are valid in accordance with the corresponding lock indicator. Channel estimate components that are not valid, in accordance with the corresponding lock indicator, may not be utilized. In accordance with an embodiment of the invention, the EQ 218 may be adapted to utilize, for example, a least mean square (LMS) algorithm for the weight calculation. The LMS algorithm may provide a good compromise between implementation complexity and performance gains. Notwithstanding, the invention is not limited in this regard, and other weight calculation algorithms may be utilized.

The HSDPA switch 220 may comprise suitable logic, circuitry and/or code that may select one of its inputs, data from the MRC 216 and data from the EQ 218 to output.

The despreader (DS) block 222 may comprise suitable logic, circuitry, and/or code that may be adapted to despread received signals that may have been previously spread through the application of orthogonal spreading codes in the transmitter. Prior to transmission of an information signal, known as a “symbol”, the transmitter may have applied an orthogonal spreading code that produced a signal comprising a plurality of chips. The DS block 222 may be adapted to generate local codes, for example Gold codes or orthogonal variable spreading factor (OVSF) codes, that may be applied to received signals through a method that may comprise multiplication and accumulation operations. Processing gain may be realized after completion of integration over a pre-determined number of chips in which the symbol is modulated.

Following despreading at the receiver, the original symbol may be extracted. WCDMA may support the simultaneous transmission of a plurality of spread spectrum signals in a single RF signal by utilizing spreading codes among the spread spectrum signals which are orthogonal to reduce multiple access interference (MAI). The receiver may extract an individual symbol from the transmitted plurality of spread spectrum signals by applying a despreading code, which may be equivalent to the code that was utilized for generating the spread spectrum signal. Similarly to the CPP block 210 and the MRC block 216, the DS block 222 may be assigned on a per base station basis, with the MRC block 216 communicating with the DS block 222 that may be assigned to the same base stations.

The diversity processor 224 may comprise a plurality of diversity processors 224a, . . . , 224n, each of which may comprise suitable logic, circuit and/or code that may be adapted to combine signals transmitted from multiple antennas in diversity modes. The diversity modes may comprise open loop (OL), closed loop 1 (CL1), and closed loop 2 (CL2). In accordance with an embodiment of the invention, the diversity mode signals may be processed in a single hardware block requiring the same received signal inputs from the MRC block 216.

The convolutional decoder 228 may comprise suitable logic, circuitry and/or code that may be utilized to handle decoding of convolutional codes as indicated in the 3GPP specification. The output of the convolutional decoder may be a digital signal, which may comprise voice information, suitable for processing by a voice processing unit. The turbo decoder 230 may comprise suitable logic, circuitry and/or code that may be utilized to handle decoding of turbo codes as indicated in the 3GPP specification. The output of the turbo decoder 230 may be a digital signal, which has data information, such that it may be suitable for use by a video display processor.

In operation, the baseband processor 200 may receive the digital baseband signal input and may communicate the single weight control signal to a phase shifter within a pre-equalization block, for example. Specifically, the CPP 210 may receive the digital baseband signal input and may generate as outputs the estimates ĥ₁ and ĥ₂ Of the actual time varying impulse response of the channel per base station, as well as a timing signal per base station. These signals may be communicated to the SWG 212, the MRC/EQ channel decision block 214, and the MRC 216. The SWG 212 may process the inputs such that it may output a single weight control signal, which may be communicated to phase shifter for shifting a phase of one or more input signals. The MRC/EQ channel block 214 may process its inputs such that it may generate the signal A1 that may be communicated to the HSDPA switch 220, such that the HSDPA switch 220 may select either the output of the MRC 216 or the output of the EQ 218 for further processing.

FIG. 2B is an exemplary maximum-ratio combining (MRC) block, in accordance with an embodiment of the invention. Referring to FIG. 2B, the maximum-ratio combining (MRC) block 200b may comprise a plurality of adders 202b, . . . , 206b, a plurality of multipliers 208b, . . . , 214b, and a plurality of delay blocks 216b, . . . , 220b. In one embodiment of the invention, the MRC block 200b may receive a plurality of channel estimates hᵢₖ (i=0,1, . . . ,L−1) from a corresponding cluster path processor block. For example, the MRC block 200b may receive estimate vectors ĥ1 and ĥ2 of the actual time varying impulse response of a channel, from a cluster path processor. Each of the estimate vectors ĥ1 and ĥ2 may comprise a cluster grid of channel estimates hᵢₖ (i=0,1, . . . ,L−1), where L may indicate the width of the cluster grid of estimates and may be related to the delay spread of the channel.

In operation, the MRC block 200b may be adapted to implement the following equation:

$${mrc}_{k} = {\sum }_{i = 0}^{L - 1} {h}_{L - 1 - i} \cdot {rx}_{k - i} ,$$

where mrcₖ is the output of the MRC block 200b, hL-1-I is the plurality of channel estimates corresponding to a channel estimate vector, such as ĥ1 and ĥ2, and rxₖ is a filtered complex input signal. The MRC block 200b may be adapted to add individual distinct path signals together in such a manner to achieve a high signal to noise ratio (SNR) in an output signal mrck.

The MRC block 200b may receive a filtered complex signal rxk from a chip-matched filter (CMF), for example. The filtered complex signal rxk may comprise in-phase (I) and quadrature (Q) components of a received signal. Furthermore, the filtered complex signal rxₖ may be gated by cluster path processor (CPP) output strobes derived from a CPP timing reference, for example. Channel estimates hik (i=0,1, . . . ,L−1) may be applied to the CMF output rxk beginning with the last in time, hL−1, and proceeding with channel estimates hL−2, . . . , h0, utilizing multiplier blocks 208b, 214b, respectively. The filtered complex input signal rxₖ may be continuously delayed by delay blocks 216b, . . . , 220b. Each delayed output of the delay blocks 216b, 220b may be multiplied by the multiplier blocks 210b, . . . , 214b, respectively, utilizing corresponding channel estimates hᵢₖ. The outputs of the multipliers 202b, . . . , 206b may be added to generate the output signal mrck, thereby implementing the above-referenced MRC equation.

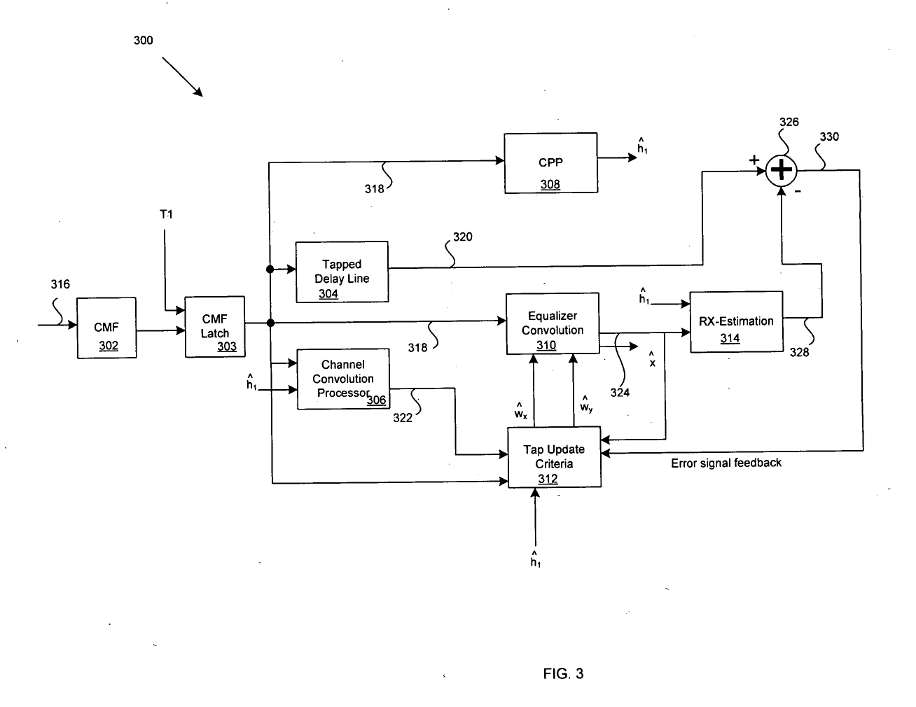

FIG. 3 illustrates exemplary signal processing circuitry which performs channel equalization, in accordance with an embodiment of the invention. Referring to FIG. 3, the exemplary signal processing circuitry 300 may comprise a chip matched filter (CMF) block 302, a tapped delay line block 304, a channel convolution block 306, a Cluster Path Processor (CPP) 308, an equalizer convolution block 310, a tap update criteria block 312, a CMF latch block 303, an RX-estimation block 314, and a received signal delay selector 326.

The CMF block 302 may comprise suitable logic, circuitry and/or code and may be adapted to filter the incoming signal 316 so as to produce in-phase and quadrature components (I, Q), for example. In this regard, in an embodiment of the invention, the CMF block 302 may comprise a plurality of digital filters that are adapted to filter corresponding in-phase (I) and quadrature (Q) components of the incoming signal 316 to within the bandwidth of WCDMA baseband of 3.84 MHz, for example.

The CPP block 308 may comprise a plurality of cluster processors that may be adapted to receive and process an output of the chip matched filter (CMF) block 302. The CPP block 308 may be partitioned into pairs of processors, wherein each pair of processors may be adapted to track time-wise and estimate a complex phase and amplitude of the element in the cluster. A cluster may comprise an aggregate of received signal multipaths with maximum (max) time difference that may be no more than L×1/3.84e6 (sec), where L may be a design parameter of the signal processing system 300. The CPP 308 may be adapted to utilize different design parameters L. Under these circumstances, the need for two processors is derived from the fact that the WCDMA standard facilitates a receiving mode in which the transmitted signal is transmitted over two antennas, which necessitates the two processors. These receiving modes may comprise close loop 1 (CL1), close loop 2 (CL2), and STTD, for example. The CPP block 308 may be adapted to generate channel estimates ĥ₁ and ĥ₂ of the actual time varying impulse response of the channel per base station. The CPP block 308 may also be adapted to generate timing information per base station. The channel estimates ĥ₁ and ĥ₂ of the actual time varying impulse response of the channel per base station may be communicated by the CPP 308 to the channel convolution block 306 and to the RX-estimation block 314 for further processing.

The tapped delay line block 304 may comprise suitable logic, circuitry and/or code and may be adapted to generate a determined delay between the chip matched filter output signal 318 and the estimated received signal output 328. The tapped delay may be utilized for effective error signal calculation within the exemplary signal processing structure 300. The received signal 316 and the received estimated signal 328 may be aligned. The tap delay line block 304 may utilize interpolating or non-interpolating taps. A non-interpolating tap may extract the signal at some fixed integer delay relative to the input signal received from the CMF block 302. In one aspect of the invention, the tapped delay may introduce a delay of duration one chip per clock cycle.

The CMF latch block 303 may comprise suitable circuitry, logic, and/or code and may be adapted to utilize a timing reference (T1), which may be derived by the CPP 308, to sample the CMF 302 output stream at the optimal timing point. The reference sampled output of the CMF latch block 303 may be communicated to the tapped delay line block 304 and the channel convolution processor 306 for further processing.

The channel convolution block 306 may comprise suitable logic, circuitry and/or code and may be adapted to receive the filtered signal from the CMF block 302 and convolute the received signal with the channel estimate ĥ₁ of the actual time varying impulse response of the channel to generate the convolution output signal 322. The convolved output signal may then be communicated to the tap update criteria block 312.

The equalizer convolution block 310 may comprise suitable logic, circuitry and/or code and may be adapted to receive a filtered signal 318 and estimated weights ŵₓ and ŵ_{y} from the adaptive NLMS algorithm within the tap update criteria block 312 and generate an equalized signal 324 and an estimate of the original transmitted data xˆ “hat.”

The RX-estimation block 314 may comprise suitable logic, circuitry and/or code and may be adapted to receive the equalized signal 324 from the equalizer convolution block 310 and convolve the equalized signal 324 with the channel estimates ĥ₁ and ĥ₂ of the actual time varying impulse response of the channel to generate the output RX estimate signal 328. The output RX estimate signal 328 may comprise an estimate of a signal received by one or more receive antennas, for example receive mobile antennas. The output RX estimate signal 328 may be utilized by the delay selector 326 to generate an error signal 330 for use by an adaptive algorithm, for example, within the tap update criteria block 312.

The tap update criteria block 312 may comprise suitable logic, circuitry and/or code and may implement an adaptive iterative algorithm to find the optimum weight solution for estimating weights ŵₓ and ŵ_{y} based on the convoluted signal 322 and the error signal feedback generated by the delay selector 326. The algorithm that may be utilized by the tap update criteria block 312 may comprise a LMS, RLS, and/or any other type of algorithm that searches for the optimum solution given any cost function. In one aspect of the invention, the cost function utilized by the tap update criteria block 312 may also be utilized to optimize the Signal-to-Noise ratio (SNR) of the received signal.

In operation, the incoming signal 316 may be filtered by the CMF 302 to generate a filtered signal 318. The filtered signal may then be communicated to the CPP 308, the tapped delay line 304, the equalizer convolution block 310, and the channel convolution block 306. The CPP block 308 may receive and process the filtered signal 318 to generate channel estimates ĥ₁ and ĥ₂ of the actual time varying impulse response of the channel. The channel estimates ĥ₁ and h₂ of the actual time varying impulse response of the channel may be communicated by the CPP 308 to the channel convolution block 306 and to the RX-estimation block 314 for further processing.

The tapped delay line block 304 may generate a determined delay between the received filtered signal 318 and the estimated signal 320. The estimated signal 320 may be communicated to the delay selector 326. The channel convolution block 306 may receive the filtered signal from the CMF block 302 and convolve the received signal with the channel estimate ĥ₁ of the actual time varying impulse response of the channel per base station to generate the convolution output signal 322. The convolved output signal may then be communicated to the tap update criteria block 312. The tap update criteria block 312 may implement an adaptive iterative algorithm to find the optimum weight solution for estimating weights ŵₓ and ŵ_{y} based on the convoluted signal 322 and the error signal feedback generated by the delay selector 326.

The equalizer convolution block 310 may receive the filtered signal 318 and estimated weights ŵₓ and ŵ_{y} from the adaptive NLMS algorithm within the tap update criteria block 312 and generate an equalized signal 324 and an estimate of the original transmitted data xˆ “hat.” The RX-estimation block 314 may receive the equalized signal 324 from the equalizer convolution block 310 and convolute the equalized signal 324 with the estimates ĥ₁ of the actual time varying impulse response of the channel per base station to generate the output RX estimate signal 328. The output RX estimate signal 328 may comprise an estimate of a signal received by one or more receive antennas, for example receive mobile antennas. The output RX estimate signal 328 may be utilized by the delay selector 326 to generate an error signal 330 for use by an adaptive algorithm, for example, within the tap update criteria block 312.

In one embodiment of the invention, an alternative structure may be utilized for TAP update. For example, the RX Estimation block 314 and the channel convolution processor block 306 may be removed to produce a structure which may minimize the mean square error. The TAP update criteria may then utilize, for example, a CMF 302 input, an equalizer output, and a CPP channel estimate to perform a tap update in accordance with a minimum mean square error criteria. A direct method may also be utilized, where the Tap update criteria may operate on the estimated channel impulse response function ĥ₁.

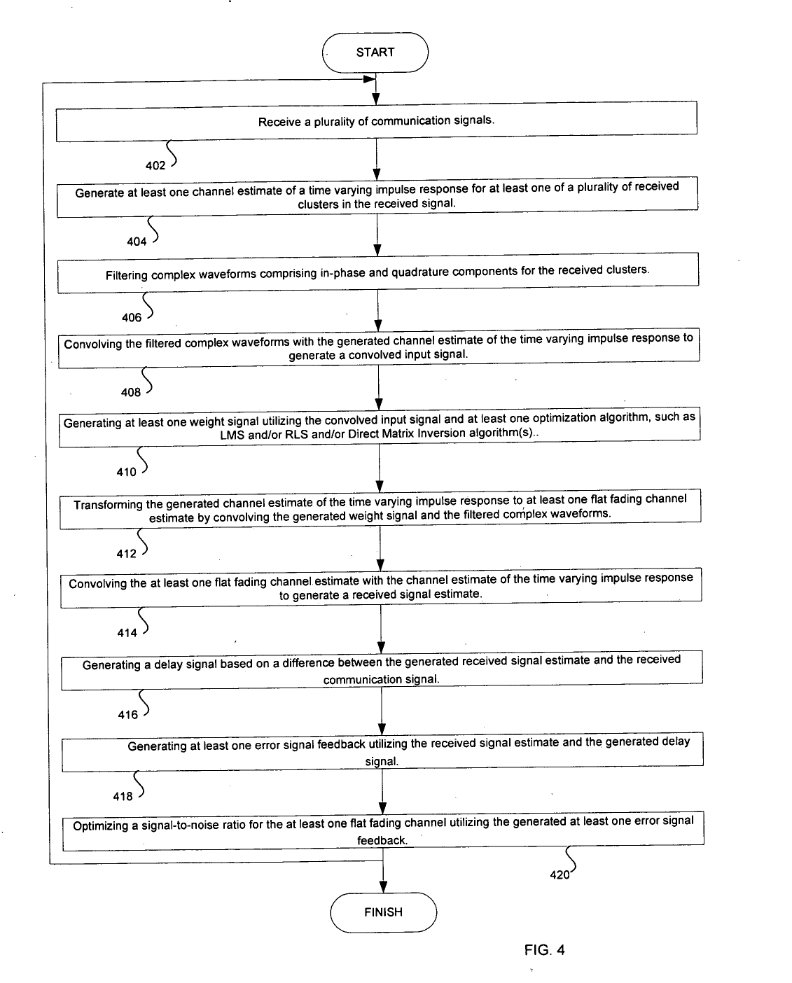

FIG. 4 is a flow diagram of illustrating exemplary steps for signal equalization, in accordance with an embodiment of the invention. Referring to FIG. 4, at 402, a plurality of communication signals may be received by a receiver. At 404, at least one channel estimate of a time varying impulse response for at least one of a plurality of received clusters in the received signal may be generated. At 406, complex waveforms comprising in-phase and quadrature components for the received clusters may be filtered. At 408, the filtered complex waveforms may be convolved with the generated channel estimate of the time varying impulse response to generate a convolved input signal. At 410, at least one weight signal may be generated utilizing the convolved input signal and at least one optimization algorithm, such as LMS and/or RLS and/or Direct Matrix Inversion algorithm(s). U.S. application Ser. No. ______ (Attorney Docket No. 16218US02) provides description of signal clusters and is hereby incorporated herein by reference in its entirety.

At 412, the generated channel estimate of the time varying impulse response may be transformed to at least one flat fading channel estimate by convolving the generated weight signal and the filtered complex waveforms. At 414, the flat fading channel estimate may be convolved with the channel estimate of the time varying impulse response to generate a received signal estimate. At 416, a delay signal may be generated based on a difference between the generated received signal estimate and the received communication signal. At 418, an error signal feedback may be generated utilizing the received signal estimate and the generated delay signal. At 420, a signal-to-noise ratio for the at least one flat fading channel may be optimized utilizing the generated error signal feedback.

Certain embodiments of the invention may be found in a method and system for processing signals in a receiver. Aspects of the method may comprise generating at least one channel estimate of a time varying impulse response for at least one of a plurality of received clusters within at least one received signal, where a cluster may comprise an aggregate of continuously processed received multipaths. The generated channel estimate may be transformed to at least one flat fading channel estimate utilizing at least one signal-to-noise ratio optimization algorithm. Complex waveforms, comprising in-phase (I) and quadrature (Q) components may be processed for the plurality of received clusters within the received signal, and the processed complex waveforms may be filtered. The filtered processed waveforms may be convolved with the generated channel estimate to generate a convolved input signal.

A weight signal for the transforming may be generated, utilizing the signal-to-noise ratio optimization algorithm and/or the generated convolved input signal. The at least one signal-to-noise ratio optimization algorithm may comprise a least mean square (LMS) algorithm and/or a recursive least square (RLS) algorithm, for example. The flat fading channel may be convolved with the channel estimate to generate a received signal estimate. A delay signal may be generated, which may be based on a difference between the generated received signal estimate and the received signal. An error signal feedback may be generated utilizing the received signal estimate and the generated delay signal. A signal-to-noise ratio for the flat fading channel may be optimized utilizing the generated error signal feedback.

Another embodiment of the invention may provide a machine-readable storage, having stored thereon, a computer program having at least one code section executable by a machine, thereby causing the machine to perform the steps as described above for processing signals in a receiver.

Aspects of the system may comprise a channel estimator, for example, the CPP block 210 (FIG. 2), that may be adapted to generate at least one channel estimate of a time varying impulse response for at least one of a plurality of received clusters within at least one received signal. The cluster may comprise an aggregate of continuously processed received multipaths. The system may also comprise an equalizer 218 (FIG. 2) that transforms the generated channel estimate to at least one flat fading channel estimate utilizing at least one signal-to-noise ratio optimization algorithm. A filter, for example, the CMF block 302 (FIG. 3), may be utilized to process complex waveforms comprising in-phase (I) and quadrature (Q) components for the plurality of received clusters and the filter may filter the processed complex waveforms comprising the in-phase and quadrature components. A channel convolution processor 306 (FIG. 3) may convolve the filtered processed waveforms with the generated at least one channel estimate of the time varying impulse response to generate a convolved input signal.

A weight signal generator, for example, the tap update criteria block 312 (FIG. 3), may be adapted to generate a weight signal for the transforming utilizing the signal-to-noise ratio optimization algorithm and/or the convolved input signal. The signal-to-noise ratio optimization algorithm may comprise a least mean square (LMS) algorithm and/or a recursive least square (RLS) algorithm. A received signal estimator, for example, the RX-estimation block 314 (FIG. 3), may convolve the flat fading channel with the generated channel estimate of the time varying impulse response to generate a received signal estimate. Delay circuitry may be utilized to generate a delay signal based on a difference between the generated received signal estimate and the received signal. A feedback signal generator, for example, the delay selector 326, may be utilized to generate an error signal feedback utilizing the received signal estimate and the generated delay signal. The equalizer, for example, the tap update criteria block 312 (FIG. 3), may optimize a signal-to-noise ratio for the flat fading channel utilizing the generated error signal feedback.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods descry bed herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing signals in a receiver, the method comprising:
generating at least one channel estimate of a time varying impulse response for at least one of a plurality of received clusters within at least one received signal, wherein a cluster comprises an aggregate of continuously processed received multipaths; and
transforming said generated at least one channel estimate of said time varying impulse response for said at least one of said plurality of received clusters to at least one flat fading channel estimate utilizing at least one signal-to-noise ratio optimization algorithm.

2. The method according to claim 1, further comprising processing complex waveforms comprising in-phase (I) and quadrature (Q) components for said plurality of received clusters within said at least one received signal.

3. The method according to claim 2, further comprising filtering said processed complex waveforms comprising said in-phase and quadrature components.

4. The method according to claim 3, further comprising convolving said filtered processed waveforms with said generated at least one channel estimate of said time varying impulse response to generate a convolved input signal.

5. The method according to claim 4, further comprising generating at least one weight signal for said transforming utilizing said at least one signal-to-noise ratio optimization algorithm and said convolved input signal.

6. The method according to claim 1, wherein said at least one signal-to-noise ratio optimization algorithm comprises at least one of a least mean square (LMS) algorithm and a recursive least square (RLS) algorithm.

7. The method according to claim 1, further comprising convolving said at least one flat fading channel with said generated at least one channel estimate of said time varying impulse response to generate at least one received signal estimate.

8. The method according to claim 7, further comprising generating a delay signal based on a difference between said generated at least one received signal estimate and said at least one received signal.

9. The method according to claim 8, further comprising generating at least one error signal feedback utilizing said at least one received signal estimate and said generated delay signal.

10. The method according to claim 9, further comprising optimizing a signal-to-noise ratio for said at least one flat fading channel utilizing said generated at least one error signal feedback.

11. A machine-readable storage having stored thereon, a computer program having at least one code section for processing signals in a receiver, the at least one code section being executable by a machine for causing the machine to perform steps comprising:
generating at least one channel estimate of a time varying impulse response for at least one of a plurality of received clusters within at least one received signal, wherein a cluster comprises an aggregate of continuously processed received multipaths; and
transforming said generated at least one channel estimate of said time varying impulse response for said at least one of said plurality of received clusters to at least one flat fading channel estimate utilizing at least one signal-to-noise ratio optimization algorithm.

12. The machine-readable storage according to claim 11, further comprising code for processing complex waveforms comprising in-phase (I) and quadrature (Q) components for said plurality of received clusters within said at least one received signal.

13. The machine-readable storage according to claim 12, further comprising code for filtering said processed complex waveforms comprising said in-phase and quadrature components.

14. The machine-readable storage according to claim 13, further comprising code for convolving said filtered processed waveforms with said generated at least one channel estimate of said time varying impulse response to generate a convolved input signal.

15. The machine-readable storage according to claim 14, further comprising code for generating at least one weight signal for said transforming utilizing said at least one signal-to-noise ratio optimization algorithm and said convolved input signal.

16. The machine-readable storage according to claim 11, wherein said at least one signal-to-noise ratio optimization algorithm comprises at least one of a least mean square (LMS) algorithm and a recursive least square (RLS) algorithm.

17. The machine-readable storage according to claim 11, further comprising code for convolving said at least one flat fading channel with said generated at least one channel estimate of said time varying impulse response to generate at least one received signal estimate.

18. The machine-readable storage according to claim 17, further comprising code for generating a delay signal based on a difference between said generated at least one received signal estimate and said at least one received signal.

19. The machine-readable storage according to claim 18, further comprising code for generating at least one error signal feedback utilizing said at least one received signal estimate and said generated delay signal.

20. The machine-readable storage according to claim 19, further comprising code for optimizing a signal-to-noise ratio for said at least one flat fading channel utilizing said generated at least one error signal feedback.

21. A system for processing signals in a receiver, the system comprising:
a channel estimator that generates at least one channel estimate of a time varying impulse response for at least one of a plurality of received clusters within at least one received signal, wherein a cluster comprises an aggregate of continuously processed received multipaths; and
an equalizer that transforms said generated at least one channel estimate of said time varying impulse response for said at least one of said plurality of received clusters to at least one flat fading channel estimate utilizing at least one signal-to-noise ratio optimization algorithm.

22. The system according to claim 21, further comprising a filter that processes complex waveforms comprising in-phase (I) and quadrature (Q) components for said plurality of received clusters within said at least one received signal.

23. The system according to claim 22, wherein said filter filters said processed complex waveforms comprising said in-phase and quadrature components.

24. The system according to claim 23, further comprising a channel convolution processor that convolves said filtered processed waveforms with said generated at least one channel estimate of said time varying impulse response to generate a convolved input signal.

25. The system according to claim 24, further comprising a weight signal generator that generates at least one weight signal for said transforming utilizing said at least one signal-to-noise ratio optimization algorithm and said convolved input signal.

26. The system according to claim 21, wherein said at least one signal-to-noise ratio optimization algorithm comprises at least one of a least mean square (LMS) algorithm and a recursive least square (RLS) algorithm.

27. The system according to claim 21, further comprising a received signal estimator that convolves said at least one flat fading channel with said generated at least one channel estimate of said time varying impulse response to generate at least one received signal estimate.

28. The system according to claim 27, further comprising delay circuitry that generates a delay signal based on a difference between said generated at least one received signal estimate and said at least one received signal.

29. The system according to claim 28, further comprising a feedback signal generator that generates at least one error signal feedback utilizing said at least one received signal estimate and said generated delay signal.

30. The system according to claim 29, wherein said equalizer optimizes a signal-to-noise ratio for said at least one flat fading channel utilizing said generated at least one error signal feedback.
